(19) United States
(12) Patent Application Publication
(10) Pub. No.: US 2011/0107868 A1
(43) Pub. Date: May 12, 2011

(54) KEY MODULE WITH MULTI-COLOR MARKS

(75) Inventors: DA-YU WANG, Shenzhen (CN); YAN-DONG ZHU, Shenzhen (CN)

(73) Assignee: HON HAI PRECISION INDUSTRY CO., LTD., Tu-Cheng (TW)

(21) Appl. No.: 12/943,035

(22) Filed: Nov. 10, 2010

(30) Foreign Application Priority Data
Nov. 10, 2009 (CN) 200910309495.5

(51) Int. Cl. G05G 1/02

(52) U.S. Cl. 74/491

(57) ABSTRACT

A key module includes a front panel, a light guide plate disposed under the front panel and a plurality of a plurality of elastic knobs disposed under the light guide plate. The front panel is divided to a plurality of push areas. The elastic knobs are corresponding to the push areas. Each push area defines an array of micropores running through the front panel. An inner face of each micropore is uneven.

### BACKGROUND OF THE INVENTION

1. Field of the Invention

The present invention relates to a key module, and more particularly to a key module with multi-color marks.

2. Description of the Related Art

TW Patent Publication No. 200923994 published on Jun. 1, 2009 discloses a key module. The key module comprises a metal laminate etched to form a plurality of micropores, a pattern layer formed on a side of the metal laminate and a backlight module formed on the other side of the metal laminate. The arrayed micropores are configured with characters or drawings. When the backlight module enters lights to the metal laminate, the lights run through the micropores to show shapes of the characters or drawing. The pattern layer defines a plurality of orbicular lines to show ripple shine. A manufacture process of the pattern layer is complicated. How to manufacture a multi-color key module is considered.

In view of the above, a key module that overcomes the above-mentioned disadvantages is desired.

### SUMMARY OF THE INVENTION

Accordingly, an object of the present invention is to provide a key module with multi-color marks.

To fulfill the above-mentioned object, a key module includes a front panel, a light guide plate disposed under the front panel and a plurality of a plurality of elastic knobs disposed under the light guide plate. The front panel is divided to a plurality of push areas. The elastic knobs are corresponding to the push areas. Each push area defines an array of micropores running through the front panel. An inner face of each micropore is uneven.

Other objects, advantages and novel features of the invention will become more apparent from the following detailed description when taken in conjunction with the accompanying drawings.

### BRIEF DESCRIPTION OF THE DRAWINGS

FIG. 1 is a top exploded view of a key module of the present invention;

FIG. 2 is a bottom exploded view of the key module of FIG. 1;

FIG. 3 is an enlarged view of a part of the key module as shown in a circular ring in FIG. 1; and

FIG. 4 is an enlarged cross sectional view of a micropore of FIG. 3.

### DETAILED DESCRIPTION OF THE PREFERRED EMBODIMENT OF THE INVENTION

Reference will now be made to the drawings to describe the present invention in detail.

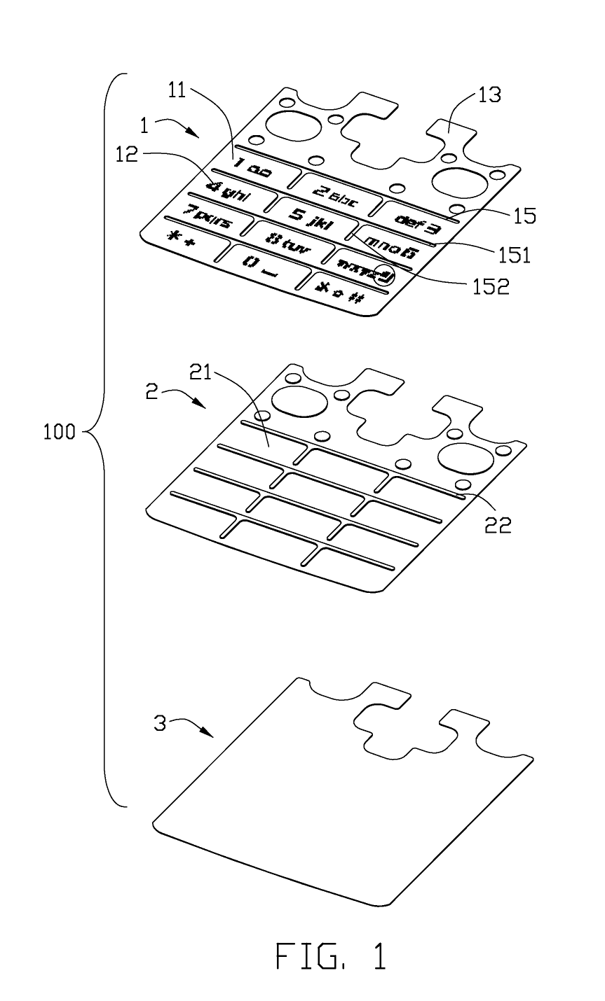

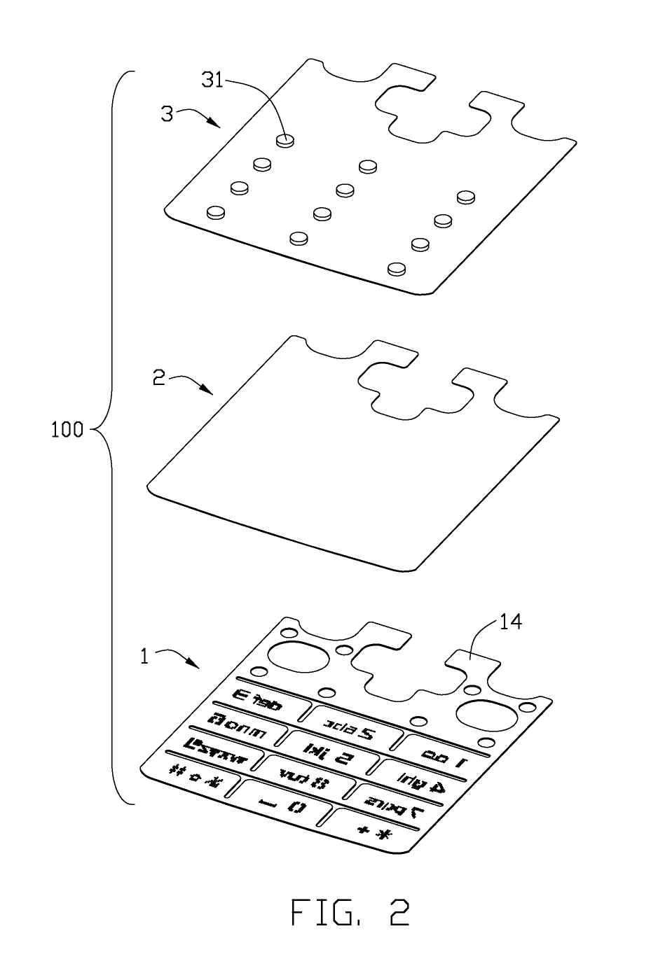

Referring to FIGS. 1-2, a key module 100 comprises a front panel 1, a light guide plate 2 and an actuator plate 3.

Referring to FIGS. 1-2, the front panel 1 is made from a metal sheet and divided to a plurality of push areas 11 by a plurality of partition slits 15. Each push area 11 is formed marks 12 such as one numeral and three characters. When one push area is pushed, the other push areas are not moved. The partition slits 15 are arranged in rows and columns pattern, each partition line 15 includes a lengthwise portion 151 in a first direction and two widthwise portions 152 extending from two different locations of the lengthwise portion 151 in a second direction perpendicular to the first direction.

The light guide plate 2 is located under and attached to the front panel 1. The light guide plate is made from thermoplastic polyurethanes (TPU). The light guide plate 2 is divided to a plurality of light guide areas 21 corresponding to the push areas 11 by a plurality of partition ribs 22. The partition ribs 22 are accommodated in the partition slits 15. The partition slits 15 have a same shape to the partition ribs 22.

The actuator plate 3 is located under and attached to the light guide plate 2. The actuator plate 3 is made from rubber material and protrudes a plurality of elastic knobs 31 away from the light guide plate 2. The elastic knobs 31 correspond to the light guide areas 21 and the push areas 11.

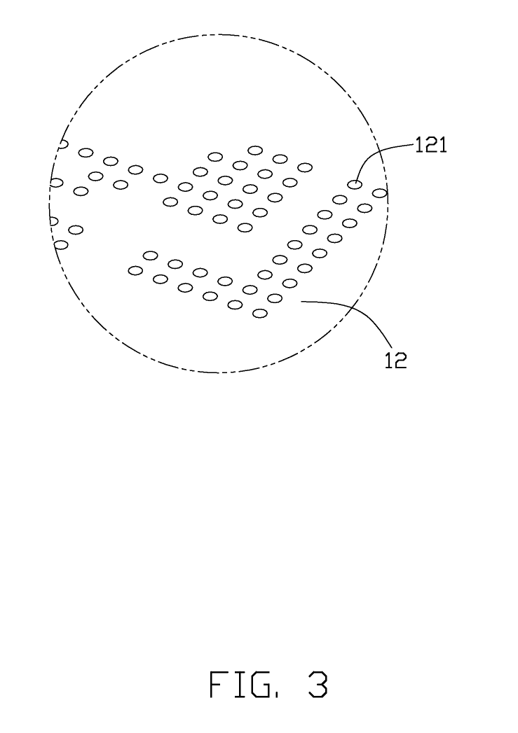

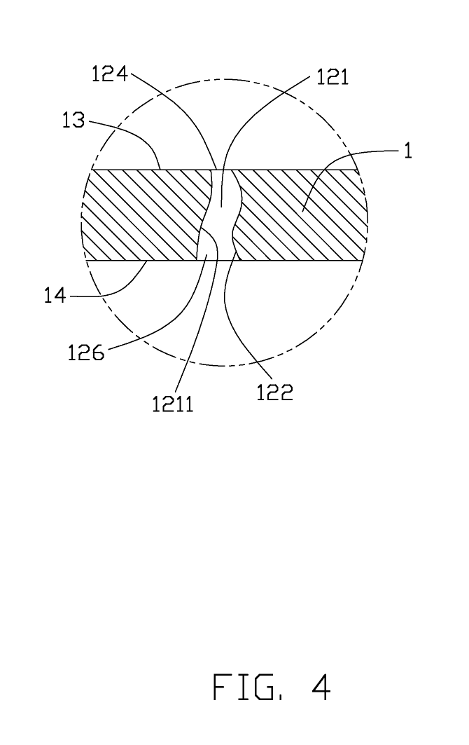

Referring to FIGS. 3-4, the marks 12 are displayed by arrays of micropores 121. The micropores 121 are formed by laser's engraving. The front panel 1 defines a front face 13 and a bottom face 14. The micropores 121 run through the front face 13 and the bottom face 14 and respectively form first opens 124 on the front face 13 and second opens 126 on the bottom face 14. Radiuses of the first opens 124 are smaller than radiuses of the second opens 126. Inner faces 1211 of the micropores 121 are uneven. The light guide plate 2 contacts with the bottom face 14 of the front panel 1. When a light emitting source (not shown) enters lights to the light guide plate 2, the lights run through the light guide plate 2 to the micropores 121 to show shapes of the marks 12. The lights have the different refractive indexes due to the different colors. When the lights run through the light guide plate 2, the lights are divided to different beams of light of different colors. When entering the inner faces 1211 of the micropores 121, the different beams of light of different colors disperse to different directions to show different colors in different angle of view.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A key module comprising:
a front panel divided to a plurality of push areas and each push area defining an array of micropores running through the front panel;
a light guide plate disposed under the front panel;
a plurality of elastic knobs disposed under the light guide plate and corresponding to the push areas;
wherein an inner face of each micropore is uneven.

2. The key module as claimed in claim 1, wherein the front panel is made from a metal sheet.

3. The key module as claimed in claim 2, wherein the micropores are formed by laser's engraving.

4. The key module as claimed in claim 3, wherein the micropores are configured with marks.

5. The key module as claimed in claim 4, wherein the micropores define first openings at a top face of the front panel and second openings at a bottom face of the front panel, radiuses of the first openings are smaller than radiuses of the second openings.

6. The key module as claimed in claim 1, wherein the key module comprises an actuator plate disposed under the light guide plate, the elastic knobs protrude from the actuator plate.

7. The key module as claimed in claim 6, wherein the actuator plate is made from rubber material.

8. The key module as claimed in claim 7, wherein the light guide plate is made from thermoplastic polyurethanes material.

9. The key module as claimed in claim 1, wherein the front panel is divided with the push areas by a plurality of partition slits and the light guide plate is divided with a plurality of light guide areas corresponding to the push areas by the partition ribs, the partition slits have a same shape to the partition ribs.

10. A key module comprising:
a front panel defining a plurality of marks configured by arrays of micropores;
a light guide plate disposed under the front panel and contacting with the front panel;
a plurality of elastic knobs disposed under the light guide plate and corresponding to the marks;
wherein the micropores are formed by laser's engraving.

11. The key module as claimed in claim 10, wherein the key module comprises an actuator plate disposed under the light guide plate, the elastic knobs protrude from the actuator plate and away from the light guide plate.

12. A key module for use with a multi-color light, comprising:
a front panel divided to a plurality of push areas and each push area defining an array of micropores extending along an up-and-down direction in the front panel to show different marks thereon;
a light guide plate disposed under the front panel; and
a plurality of elastic knobs disposed under the light guide plate and corresponding to the push areas; wherein
the light guide plate is characterized to divide said multi-color light from a light source thereabouts into different light beams, and an outer surface of each of said micropores is configured to disperse said divided light beams outwardly and forwardly in different directions.

13. The key module as claimed in claim 12, wherein said micropores extend through the front panel without transparent material filled therein.

14. The key module as claimed in claim 12, wherein said outer surface is irregular.
